(19) United States
(12) Patent Application Publication
(10) Pub. No.: US 2020/0376503 A1
(43) Pub. Date: Dec. 3, 2020

(54) Fluidic Assembly

(71) Applicant: FDX Fluid Dynamix GmbH, Berlin (DE)

(72) Inventors: Jens Hermann Wintering, Berlin (DE); Bernhard Bobusch, Berlin (DE); Oliver Krüger, Berlin (DE)

(21) Appl. No.: 16/606,803

(22) PCT Filed: Apr. 12, 2018
(86) PCT No.: PCT/EP2018/059474

§ 371 Date: Oct. 21, 2019

(30) Foreign Application Priority Data
Apr. 24, 2017 (DE) 10 2017 206 849.3

(51) Int. Cl. B05B 1/08; A47L 15/42; D06F 39/08; B08B 3/02

(52) U.S. Cl. CPC B05B 1/08; A47L 15/4278; F02M 55/008; B08B 3/02; D06F 39/088

(57) ABSTRACT

A fluidic assembly having a fluidic component includes a flow chamber which is traversable by a fluid flow which enters into the flow chamber through an inlet opening of the flow chamber and emerges from the flow chamber through an outlet opening of the flow chamber. The fluidic component includes at least one device for realizing an oscillation of the fluid flow at the outlet opening. The oscillation is effected in an oscillation plane. The fluidic assembly includes a device for diverting the oscillating fluid flow which emerges from the outlet opening of the fluidic component. The diverting is variable over time.

The invention relates to a fluidic assembly according to the preamble of claim 1. The fluidic assembly is provided for generating a moving fluid jet.

Nozzles, which are set into motion by means of kinematics or by means of a (moving) device, are disclosed in the prior art for generating a moving fluid jet. The kinematics or (moving) device include moving components which are exposed to a high degree of wear. The costs linked to production and maintenance are correspondingly high. In addition, a relatively large installation space is necessary overall on account of the moving components.

Fluidic components, which generate a fluid jet which oscillates in a plane, are additionally disclosed for generating a moving fluid flow (or fluid jet). The fluidic components do not include any moving components which serve for generating a moving fluid flow. As a result, compared to the nozzles mentioned in the introduction, they do not have the disadvantages that result from the moving components.

However, the fluid flow, which can be generated with the fluidic components disclosed up to now, moves first and foremost in a plane (oscillation plane) and not in three-dimensional space. A three-dimensional movement of the fluid jet, in the case of some applications such as, for example, dishwashers and washing machines, can increase the cleaning performance of said fluid jet. In order to widen the fluid jet perpendicularly to the oscillation plane in the case of fluidic components disclosed up to now, a so-called divergent portion of the component is enlarged perpendicularly to the oscillation plane, as is disclosed, for example, in U.S. Pat. No. 7,014,131 B1, 7,134,609 B1 or US 2006/0065765 A1. The divergent portion of the fluidic component is arranged downstream of the outlet of the component. In addition, bursting open the fluid jet by means of obstructions in the region of the outlet is known (U.S. Pat. No. 7,014,131 B1 or EP 1937412 B1). A further possibility is to stack multiple fluidic components in such a manner that the oscillation planes thereof are substantially parallel to one another, as is disclosed, for example, in U.S. Pat. No. 7,111,800 B2. However, in the case of the named methods, a fluid jet oscillating in a plane is simply widened perpendicularly to said plane. A three-dimensional movement of a compact fluid jet at the outlet of the component cannot be achieved.

The object underlying the present invention is to create a device which is realized to generate a compact, three-dimensionally moving fluid jet, the device comprising a high degree of reliability and correspondingly low expenditure on maintenance.

Said object is achieved according to the invention by a fluidic assembly with the features of claim 1. Designs of the invention are specified in the subclaims.

The fluidic assembly accordingly includes a fluidic component which comprises a flow chamber. The flow chamber is traversable by a fluid flow which enters into the flow chamber through an inlet opening of the flow chamber and emerges from the flow chamber through an outlet opening of the flow chamber. At least one means for realizing an oscillation of the fluid flow is provided for generating a fluid flow which oscillates in an oscillation plane at the outlet opening. The means for realizing an oscillation can be, for example, at least one secondary flow channel. Other means for realizing an oscillation of the fluid flow can also be provided as an alternative to this. Said fluidic component predefines a basic flow direction of the fluid flow for the fluidic assembly. The fluid can be a gaseous, liquid, or multi-phase, flowable medium which can also be laden with particles. The fluid, which enters into the flow chamber through the inlet opening, can be acted upon with a pressure of between 0.0002 and 2500 bar (in relation to the ambient pressure). The pressure can preferably be between 0.005 and 1800 bar. Particularly preferred is a pressure range of between 0.05 and 1100 bar. For so-called white goods (domestic appliances, in particular washing machines and dishwashers) a pressure within the range of between 0.001 bar and 6 bar is advantageous. For applications for water distribution such as, for example, in the case of a lawn sprinkler or a cleaning spray, a pressure range of between 0.1 bar and approximately 14 bar is advantageous.

The fluidic assembly distinguishes itself as a result of a device for diverting the oscillating fluid flow, which emerges from the outlet opening of the fluidic component, being provided, wherein the diverting of the oscillating fluid flow is variable over time. The diverting is achieved as a result of transmitting kinetic energy to the fluid flow which emerges from the fluidic component. A diverting that is variable over time is to be understood as, for example, the dimension and/or the direction of the diverting varying over time. The varying over time of the diverting can be effected, in particular, periodically. The device for diverting preferably acts on the fluid flow firstly at or downstream of the outlet opening of the fluidic component.

The achievement here is that a fluid jet, which changes its movement direction three-dimensionally over time, emerges from the fluidic assembly. Depending on the design of the fluidic component and of the device for diverting, the movement profile (and consequently the spatial distribution) of the fluid jet can be adjusted. For example, a fluid jet can thus be generated which comprises a circular, elliptical or approximately rectangular cross section or emits a Lissajous curve. A three-dimensional movement profile of the fluid jet is advantageous, among other things, for mixing processes and cleaning applications.

In the arrangement according to the invention, it is possible to dispense with moving components for generating a three-dimensionally moving jet so that costs and expenditure caused by these do not arise. In addition, as a result of dispensing with moving components, the development of vibrations and noise in the fluidic component according to the invention is relatively small.

According to an embodiment, the device for diverting the fluid flow provides a means for diverting the fluid flow in a manner that is variable over time. Said means serves for transmitting energy to the fluid flow which results in the fluid flow being diverted. In the case of a provision that is variable over time, the amount of the means and/or the direction from which the means is provided, for example, can be variable over time. In particular, the means for diverting can be provided in a pulse-like manner. The means for diverting the fluid flow can include, in particular, a fluid. The fluid can be identical to the fluid to be diverted from the fluidic component or can differ from the fluid to be diverted. In the latter case, different fluids can be mixed together in this way without additional mixing path sections having to be provided. The fluid, which is provided for diverting by the device, preferably also oscillates. The achievement here can be that the resulting fluid flow oscillates in two (or more planes) and is thus realized in a three-dimensional manner. Insofar as the device for diverting provides a fluid as the means for diverting, the device for diverting predefines a secondary flow direction for the fluidic assembly, whilst the fluidic component predefines a basic flow direction of the fluid flow for the fluidic assembly. In said case, the device for diverting can be designated as the secondary flow generator and the fluidic component as the main flow generator.

The device for diverting the fluid flow can alternatively include a cooling or heating device. Other alternative devices include piezoelectric elements, shape-memory alloys or other so-called intelligent materials. Intelligent materials are to be understood as materials which react independently, without regulation from outside, to changing environmental conditions. In addition, devices for arc generation or plasma generators are conceivable for energy transmission (diverting). When using devices for energy transmission by means of plasma, the fluidic assembly preferably comprises a divergent surface downstream of the outlet which is situated opposite the device for energy transmission. The fluid jet can then draw in at said divergent surface and consequently maintain the deflection. According to a further embodiment, the device for diverting the fluid flow comprises at least one so-called zero mass flux element such as, for example, a loudspeaker. Zero mass flux elements are elements which transmit a pulse without generating a mass flux or a mass flux, the time means of which produces zero. A loudspeaker can thus generate an acoustic pulse, for example, for diverting the fluid jet. However, said alternative devices for diverting can result in an increase in the necessary installation space and in an increase in energy consumption and, where applicable, can include moving elements.

It can be provided, in particular, that the device for diverting the fluid flow is arranged in such a manner that the means for diverting the fluid flow act in such a manner on the oscillating fluid flow that the oscillating fluid flow (variable over time) is steered out of the oscillation plane. The achievement here is that the fluid flow emerging out of the outlet opening and oscillating in a plane now moves in three-dimensional space. The device for diverting the fluid flow can thus be arranged, for example, in such a manner that the means for diverting the fluid flow acts on the fluid flow substantially along an axis or a plane which encloses an angle, which is greater than 0°, with the oscillation plane of the oscillating fluid flow. The angle can be, for example, between 30° and 150°. Particularly preferred is an angle of substantially 90°. If the diverting of the fluid flow is varied periodically in a plane by the means for diverting, a fluid jet can be generated which oscillates or pulses in two different planes, namely the oscillation plane which is predefined by the fluidic component and the plane which is predefined by the device or the means for diverting. Insofar as not only the dimension of the diverting but also the direction from which the means for diverting acts on the fluid flow is varied over time, the resultant fluid jet oscillates or pulses in more than two planes. An arbitrary progression of the fluid flow can be generated as a result of suitably modulating the dimension of the diverting and of the direction from which the means for diverting acts on the fluid flow.

It can thus be provided, for example, that the means for diverting acts on the fluid flow along an axis (in a plane) from the one direction, from the opposite direction (or from a direction other than the one direction) or from both directions. Should the means for diverting act on the fluid flow from both directions, it can thus be provided, in particular, that the intensity with which the means acts on the fluid flow from both directions differs in size at any time. The means can thus act on the fluid flow alternating between the one and the opposite (other) direction. It can additionally be provided that as the intensity from the one direction is reduced, the intensity from the opposite (other) direction is increased, and vice versa. In particular, the intensity from each direction can oscillate between 0% and 100% in each case, the phases of the oscillation being displaced for both directions.

According to an embodiment, the device for diverting the fluid flow is arranged in such a manner that the means for diverting the fluid flow acts on the fluid flow directly at the outlet opening of the flow chamber of the fluidic component. The oscillation of the fluid flow is fully realized directly at the outlet opening and is not yet disturbed by external influences (geometries, pressure).

In particular, the device for diverting the fluid flow can be traversable by the means for diverting the fluid flow. The device for diverting the fluid flow can thus include a fluidic component. Here, the means for diverting can be, in particular, a fluid. In said embodiment, the fluidic assembly includes two fluidic components. On the one hand, the first fluid component, the fluid flow of which is to be diverted, and on the other hand the second fluidic component which is part of the device for diverting. As, in particular, the first fluidic component predefines the fluid flow direction, this can also be designated as the main flow generator, whilst the second fluidic component can be designated as the secondary flow generator. On the one hand, the fluid to be diverted of the first fluidic component and, on the other hand, the fluid which is prepared by the second fluidic component as means for diverting, oscillate in this case in said embodiment. In this case, the oscillation plane of the first fluidic component and the oscillation plane of the second fluidic component can enclose an angle which is greater than 0°. Said angle can be between 30° and 150°. An angle of substantially 90° is particularly preferred. The first and the second fluidic components can be realized in an identical or different manner with regard to size, shape and/or operating principle.

According to an embodiment, the device for diverting can include a separator in order to divide the means for diverting into at least two branches. The separator can be arranged downstream of the second fluidic component. The fluid which emerges from said second fluidic component can thus flow into the separator and be divided into at least two flow branches.

The separator can comprise an inlet opening and at least two outlet openings. In this case, the outlet openings of the separator can be arranged in a plane which lies in the or parallel to the oscillation plane of the second fluidic component arranged upstream. In particular, the outlet openings can be spaced apart from one another in such a manner that they are traversed alternately by the fluid flow which oscillates back and forth and emerges from the second fluidic component. The separator is consequently able to convert the oscillating fluid flow of the second fluidic component into a binary (pulsing) flow signal. The cross sectional area of each of the at least two outlet openings is preferably greater in each case than the cross sectional area of the inlet opening. Said preferred size ratio of the cross sectional areas can support the fact that at any arbitrary time only one of the at least two outlet openings is actually traversed.

According to an embodiment, the separator can open out (downstream) into at least two supply lines which each comprise at least one inlet opening and at least one outlet opening. Each supply line preferably includes precisely one inlet opening and precisely one outlet opening. In particular, the number of supply lines can correspond to the number of outlet openings of the separator, each outlet opening of the separator being assigned to a supply line. The velocity of the means for diverting in the supply lines in time average is preferably as low as possible so that the means for diverting in the supply lines pulses at a velocity of between 0 and the maximum velocity or of between a negative maximum velocity and a positive maximum velocity. In the latter case, the means for diverting flows alternately out of the supply lines and back into the supply lines.

In this case, the at least two supply lines (or the outlet openings of the supply lines) can be directed onto the oscillating fluid flow (of the first fluidic component) to be diverted, wherein the at least two supply lines (or the outlet openings of the supply lines) are directed onto the oscillating fluid flow (of the first fluidic component) on this side and on the other side of the oscillation plane of the oscillating fluid flow (of the first fluidic component). In particular, the at least two supply lines can be arranged in such a manner that they provide the means for diverting directed onto the oscillating fluid flow (of the first fluidic component) on this side and on the other side of the oscillation plane of the oscillating fluid flow (of the first fluidic component). The dimensions and geometries of the at least two supply lines can preferably be chosen in such a manner that the at least two supply lines (or the outlet openings of the supply lines) are able to reach to the outlet opening of the (first) fluidic component, from which the fluid flow to be diverted emerges. In this case, the at least two supply lines (or the outlet openings of the supply lines) can extend in each case at least over the entire width of the outlet opening of the (first) fluidic component at the outlet opening of the (first) fluidic component. The width of the outlet opening of the (first) fluidic component, in this case, is defined parallel to the oscillation plane of the emerging fluid flow to be diverted, the width extending substantially perpendicularly to the main dispersion direction of the fluid flow which is moved as intended from the inlet opening to the outlet opening (of the first fluidic component). The at least two supply lines preferably provide the means for diverting over the entire width of the outlet opening of the (first) fluidic component. As an alternative to this, the at least two supply lines can provide the means for diverting only over a portion of the width of the outlet opening of the (first) fluidic component or over the entire width of the outlet opening of the (first) fluidic component and beyond.

The invention additionally relates to a fluidic component (cup component) according to the preamble of claim 19. The cup component accordingly includes a flow chamber which is traversable by a fluid flow which enters into the flow chamber through an inlet opening of the flow chamber and emerges from the flow chamber through an outlet opening of the flow chamber, wherein the fluidic component comprises at least one means for realizing an oscillation of the fluid flow at the outlet opening. The cup component is distinguished in that the at least one means for realizing an oscillation includes an uneven number of secondary flow channels which is greater than 1. A three-dimensionally moving fluid flow can be generated with the cup component. Advantageous designs are provided in the subclaims.

The invention additionally relates to an injection system, a fluid mixing system, a fluid distributing system, a cooling system, a fire-extinguishing system and a cleaning apparatus which in each case include the fluidic assembly according to the invention and/or the cup component according to the invention. The injection system is provided for the injecting of a fuel into an internal combustion engine which is used, for example, in motor vehicles. For the injection system, an embodiment of the fluidic assembly can be used, in particular, which includes two fluidic components: a first fluidic component, the fluid flow of which is diverted by means of the device for diverting in a manner that is variable over time, and a second fluidic component as a device for diverting. In this case, the first and the second fluidic components can be traversed by different fluids, in particular by a fuel (first fluidic component) on the one hand and by air (second fluidic component) on the other hand. The cleaning apparatus is, in particular, a dishwasher, a washing machine, an industrial cleaning plant or a high-pressure cleaner. The fluid distributing system can be, in particular, an irrigation system, a lawn sprinkler or a pest management distribution system. The fluid distribution system can also be realized as a cooling system or fire-extinguishing system.

On account of the dynamic movement of the emerging fluid jet, the cooling performance or the fire-extinguishing performance of such a cooling system or fire-extinguishing system can be massively increased.

The invention is explained in more detail below by way of exemplary embodiments in connection with the drawings, in which:

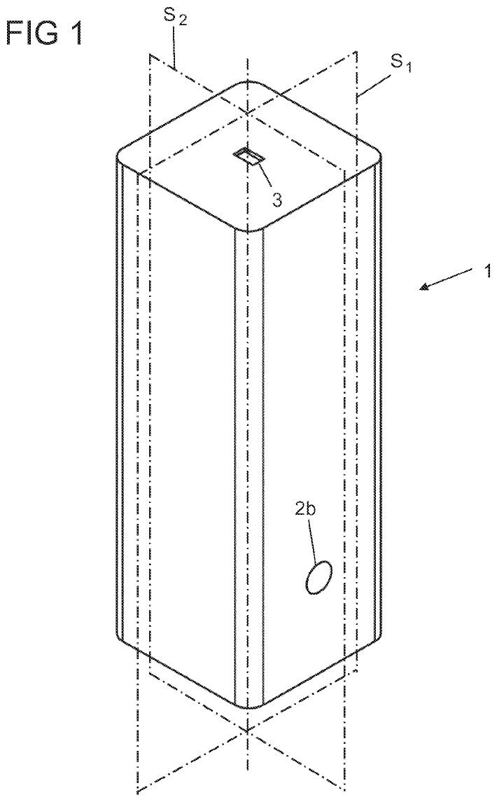

FIG. 1 shows an exterior view of a fluidic assembly according to an embodiment of the invention;

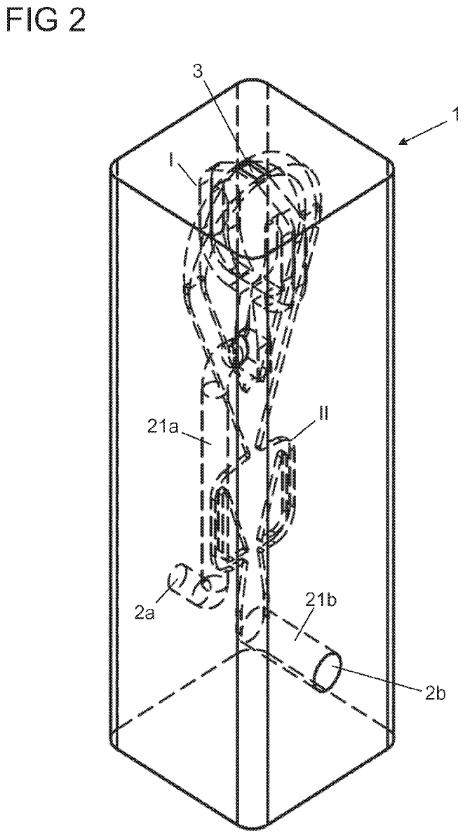

FIG. 2 shows a wireframe graphic of the fluidic assembly from FIG. 1 for visualizing the inner operating geometry;

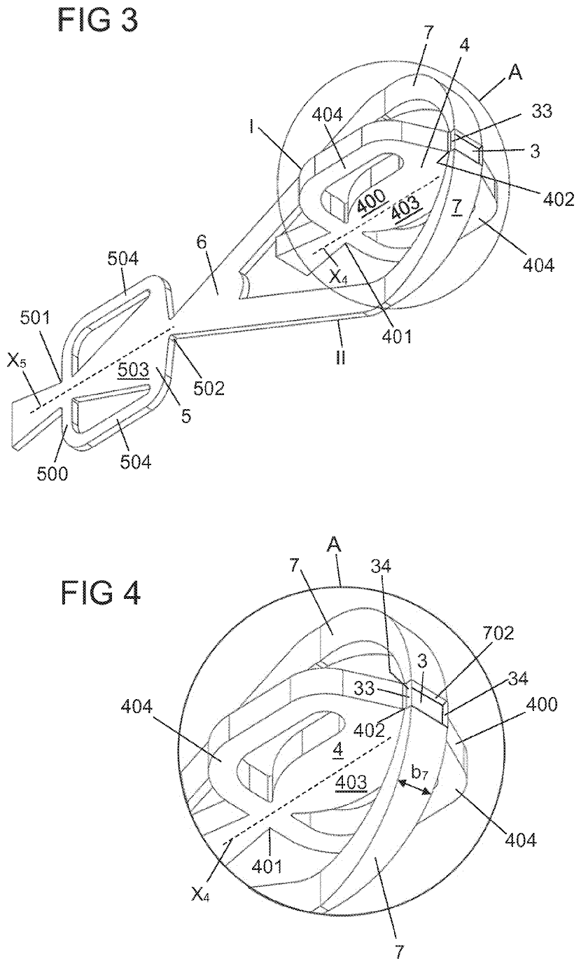

FIG. 3 shows a view of the inner operating geometry from FIG. 2 as a negative;

FIG. 4 shows an enlarged representation of the detail A from FIG. 3;

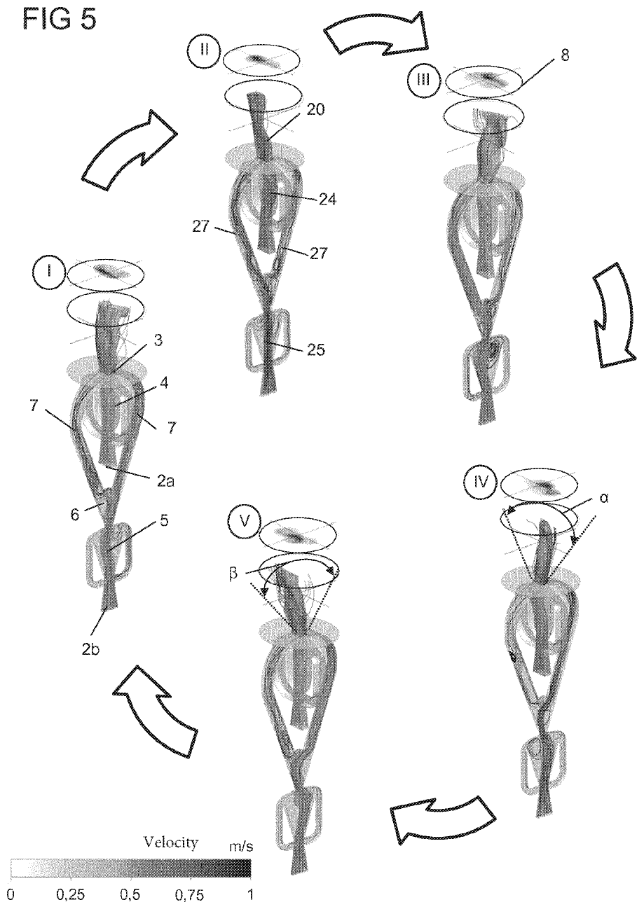

FIG. 5 shows five snapshots (images I to V) of the fluid flow in the fluidic assembly from FIGS. 1 to 4 to show the dynamics of the fluid jet emerging from the fluidic assembly;

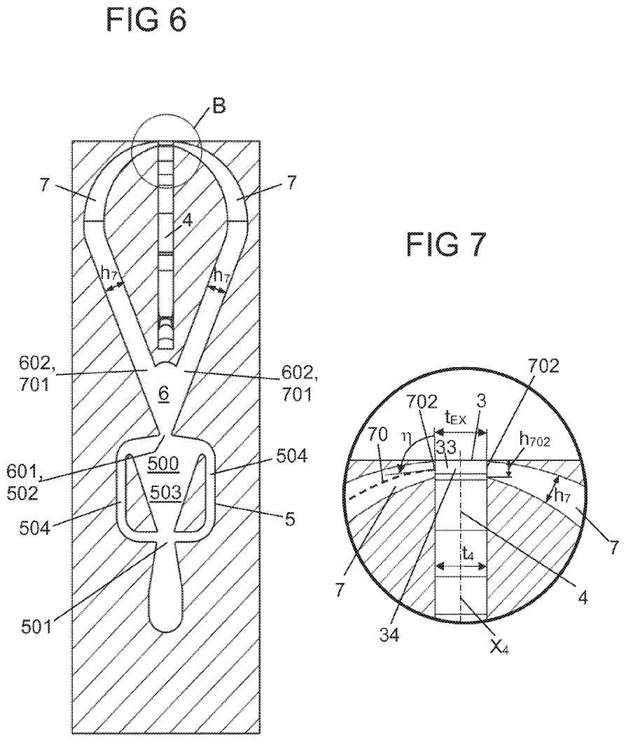

FIG. 6 shows a sectional representation of the fluidic assembly from FIG. 1 along the plane S₁;

FIG. 7 shows an enlarged representation of the detail B from FIG. 6;

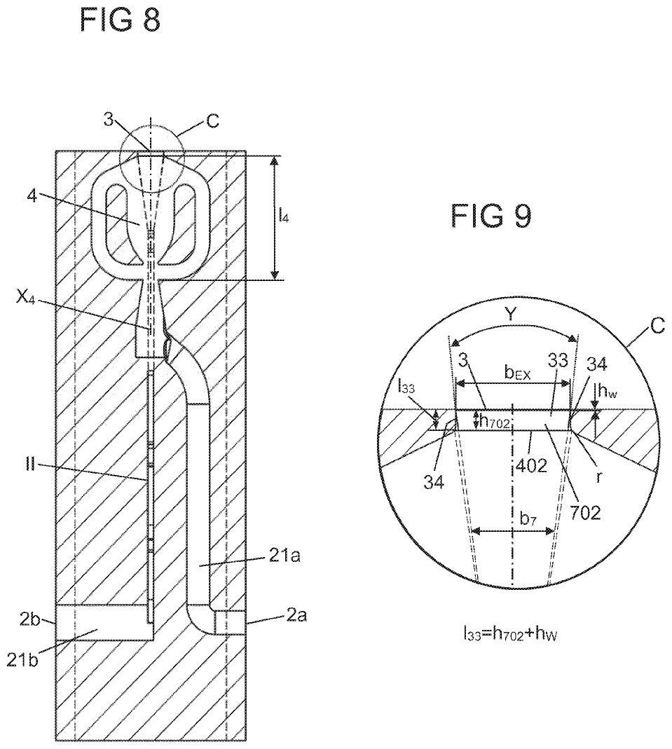

FIG. 8 shows a sectional representation of the fluidic assembly from FIG. 1 along the plane S₂;

FIG. 9 shows an enlarged representation of the detail C from FIG. 8;

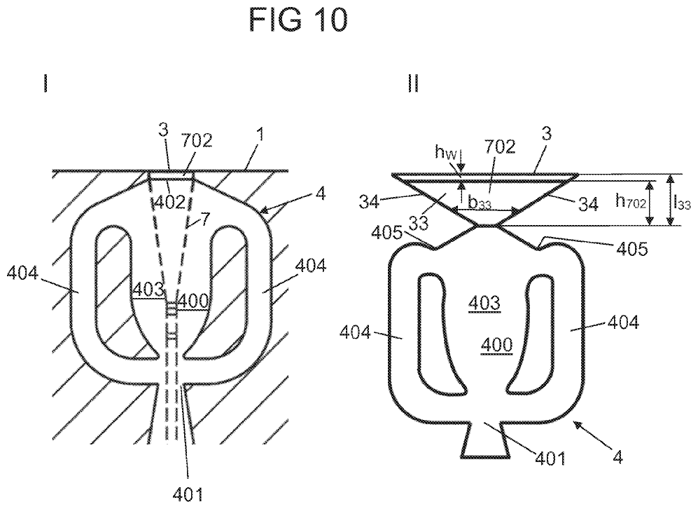

FIG. 10 shows a sectional representation (image I) of the fluidic component from FIG. 8 which serves in the fluidic assembly from FIGS. 1 to 9 as main flow generator, and a sectional representation (image II) of a fluidic component which can be used alternatively as main flow generator in the fluidic assembly;

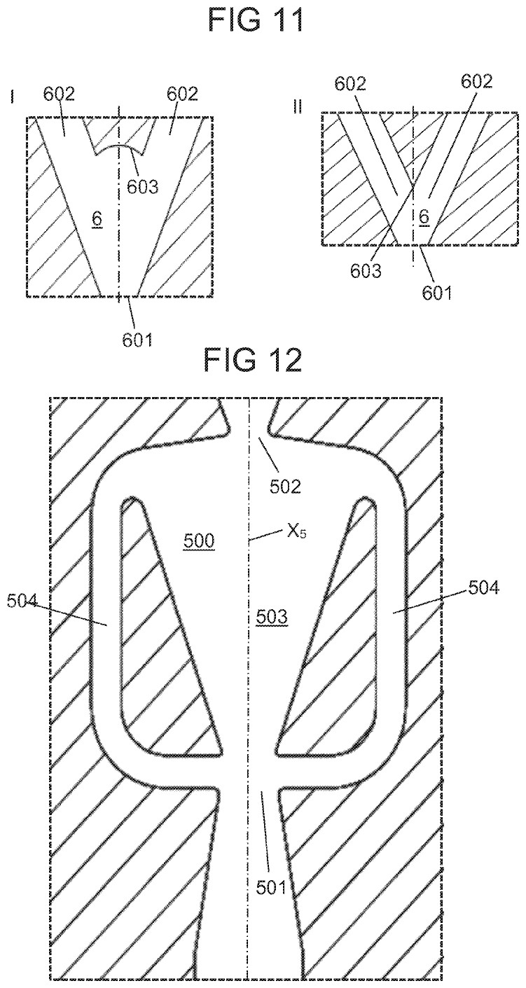

FIG. 11 shows an enlarged sectional representation (image I) of the separator of the fluidic assembly from FIG. 6 and a sectional representation (image II) of an alternative embodiment of the separators;

FIG. 12 shows an enlarged representation of the fluidic component from FIG. 6;

FIG. 13 shows a view of the inner operating geometry of a fluidic assembly according to a further embodiment as a negative;

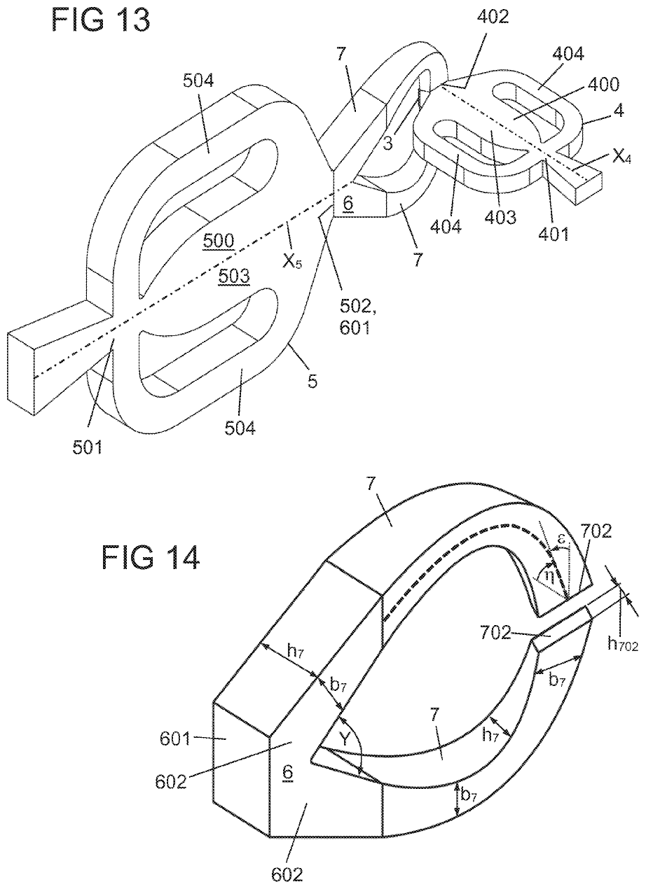

FIG. 14 shows an enlarged representation of the separator and of the supply lines of the fluidic assembly from FIG. 13;

FIG. 15 shows two snapshots (images I and II) of the oscillating jet which emerges from the fluidic assembly from FIGS. 1-9, the snapshots showing the oscillating jet from two different viewing directions at the same time;

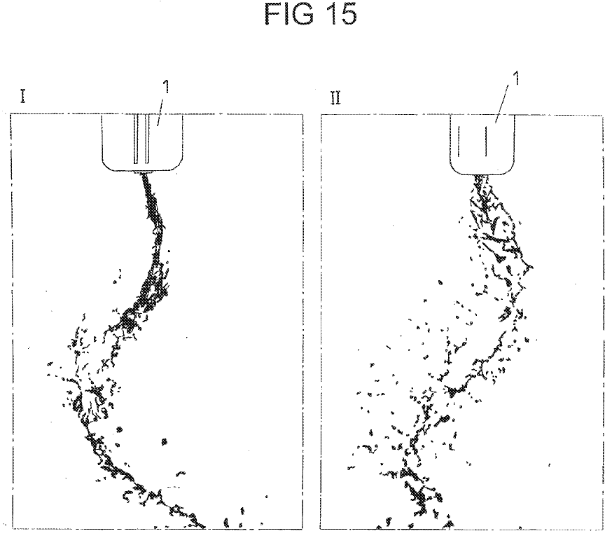

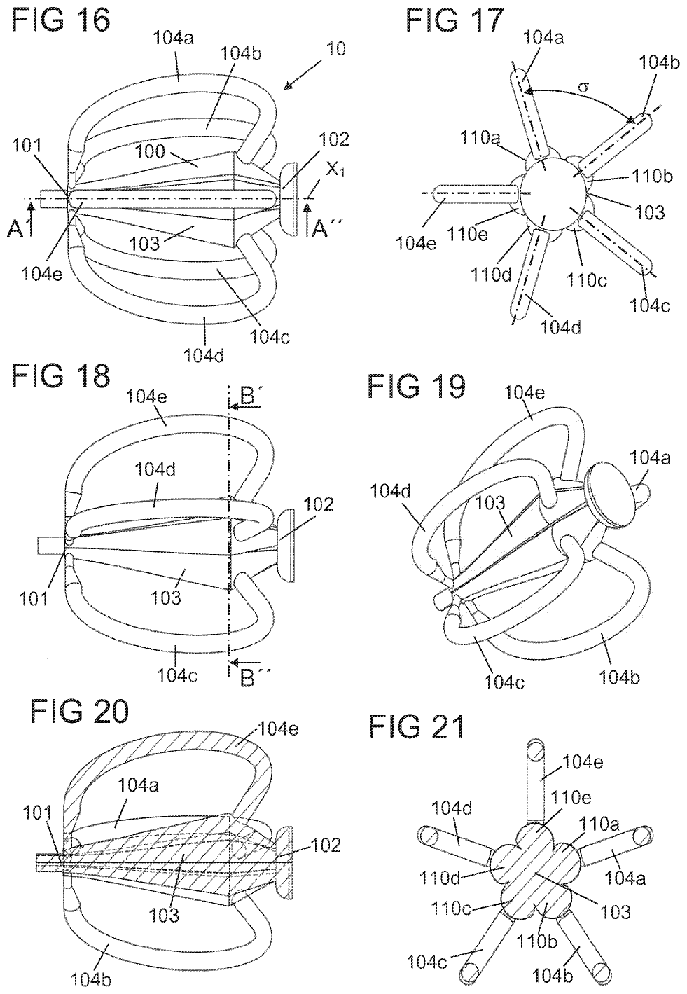

FIG. 16 shows a side view of the inner operating geometry of a cup component according to an embodiment as a negative;

FIG. 17 shows a top view of the cup component from FIG. 16;

FIG. 18 shows a further side view of the cup component from FIG. 16;

FIG. 19 shows a perspective representation of the cup component from FIG. 16;

FIG. 20 shows a sectional representation of the cup component from FIG. 16 along the line A′A″;

FIG. 21 shows a sectional representation of the cup component from FIG. 18 along the line B′B″; and

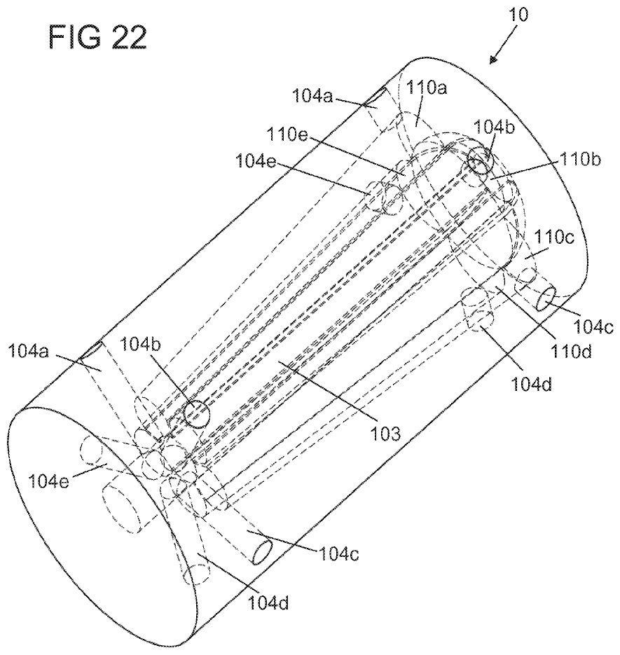

FIG. 22 shows a wireframe graphic of the cup component according to a further embodiment for visualizing the inner operating geometry.

FIG. 1 shows a schematic representation of the exterior view of a fluidic assembly 1 according to an embodiment of the invention. FIG. 2 shows the fluidic assembly 1 from FIG. 1, the inner operating geometry of said embodiment being visualized as a wireframe graphic. The fluidic assembly 1 includes two inlet openings 2a, 2b and one outlet opening 3. The outlet opening 3 is connected fluidically to each of the two inlet openings 2a, 2b. The first inlet opening 2a is connected fluidically to the outlet opening 3 via a first line 21a and a first fluidic part geometry I, whilst the second inlet opening 2b is connected fluidically to the outlet opening 3 via a second line 21b and a second fluidic part geometry II. The fluidic part geometries I and II are arranged downstream of the lines 21a or 21b. The fluidic part geometries I and II provide the cavity that is relevant to the functioning of the fluidic assembly 1. The lines 21a and 21b can be realized in an arbitrary manner. As an alternative to the embodiment shown with two inlet openings 2a, 2b, it is possible to provide only one inlet opening to which a line connects which divides downstream into two branches in order to supply the two part geometries I and II.

The fluidic assembly 1 is traversable by a fluid which enters into the fluidic assembly 1 via the inlet openings 2a, 2b and emerges from the fluidic assembly 1 via the outlet opening 3. In this case, a fluid flow, which carries out a three-dimensional movement in space at the outlet opening 3, is generated as a result of the interaction between the two part geometries I and II. The fluid can be liquid, gaseous or multi-phase and, where applicable, can also be acted upon with solid particles. In the embodiment of the fluidic assembly 1 from FIG. 1, different fluids can be supplied to the two part geometries I and II on account of the individual inlet openings 2a, 2b.

The first fluidic part geometry I is shown, in particular, in FIGS. 3, 4, 8 and 9, and the second fluidic part geometry II is shown, in particular, in FIGS. 3, 6 and 7. FIG. 3 shows the relative arrangement of the two part geometries I and II with respect to one another (for the embodiment of the fluidic assembly 1 from FIGS. 1 to 9). The fluidic part geometries I and II are connected fluidically to one another at the outlet opening 3 of the fluidic assembly 1. The first fluidic part geometry I includes a first fluidic component 4 (main flow generator) and generates a fluid flow that oscillates in an oscillation plane. The second fluidic part geometry II forms a device for diverting the fluid flow of the first fluidic component 4 and includes a second fluidic component 5 (secondary flow generator), to which a separator 6 connects downstream, followed by two supply lines 7, into which the separator 6 opens out.

The main flow generator (the first fluidic component) 4 includes a flow chamber 400 which is traversable by a fluid flow which enters into the flow chamber 400 through an inlet opening 401 and emerges from the flow chamber 400 of the main flow generator 4 through an outlet opening 402. The center points of the inlet opening 401 and of the outlet opening 402 lie on an axis X₄, which predefines the main flow direction of the fluid inside the first fluidic component 4. The flow chamber 400 includes a main flow channel 403 and two secondary flow channels (feedback channels) 404. The secondary flow channels 404 are provided as means for realizing an oscillation of the fluid flow. The secondary flow channels 404 and the main flow channel 403 are arranged substantially in a plane, the main flow channel 403 being arranged between the two secondary flow channels 404. A fluid flow, which oscillates in an oscillation plane which is parallel to the plane in which the two secondary flow channels 404 and the main flow channel 403 are arranged, is generated at the outlet opening 402 by means of the two secondary flow channels 403. In this case, the fluid flow oscillates between two maximum deflections which define the oscillation angle α of the fluid flow of the main flow generator 4. The oscillation angle α of the main flow generator 4 can be between ±1° and ±89°, the oscillation angle α being defined here in the oscillation plane with reference to the axis X₄ of the main flow generator 4. The oscillation angle α of the main flow generator 4 is preferably between ±2.5° and ±70°. In a particularly preferred manner, the oscillation angle α of the main flow generator 4 is between ±2.5° and ±60°. The oscillation angle α is adjustable depending on the area of application of the fluidic assembly 1. The oscillation angle α is influenced mainly by the geometry of the main flow generator 4.

As an alternative to this, other types of fluidic components can also be used as the main flow generator 4, for example such which generate an oscillating fluid jet by means of colliding fluid jets or in another way (without secondary flow channels). The only important thing is that the main flow generator 4 generates a fluid jet which wanders back and forth, that is which oscillates.

The secondary flow generator (the second fluidic component) 5 corresponds to the main flow generator 4 as regards operating principle. The secondary flow generator 5 (FIGS. 6 and 12) includes a flow chamber 500 which is traversable by a fluid flow which enters into the flow chamber 500 through an inlet opening 501 and emerges from the flow chamber 500 through an outlet opening 502. The center points of the inlet opening 501 and of the outlet opening 502 lie on an axis X₅, which predefines the main flow direction inside the second fluidic component 5. The flow chamber 500 includes a main flow channel 503 and two secondary flow channels (feedback channels) 504. The secondary flow channels 504 are provided as means for realizing an oscillation of the fluid flow. The secondary flow channels 504 and the main flow channel 503 are arranged substantially in a plane, the main flow channel 503 being arranged between the two secondary flow channels 504. A fluid flow, which oscillates in an oscillation plane which is parallel to the plane in which the two secondary flow channels 504 and the main flow channel 503 are arranged, is generated at the outlet opening 502 by means of the two secondary flow channels 503. In this case, the fluid flow oscillates between two maximum deflections which define the oscillation angle ß of the fluid flow of the secondary flow generator 5. The oscillation angle ß of the secondary flow generator 5 can be between ±0.25° and ±85°, the oscillation angle ß being defined here in the oscillation plane with reference to the axis X₅ of the secondary flow generator 5. The oscillation angle ß of the secondary flow generator 4 is preferably between ±1° and ±70°. In a particularly preferred manner, the oscillation angle ß of the secondary flow generator 4 is between ±2.5° and ±50°. Similarly to in the case of the main flow generator 4, different types of fluidic components can be used as secondary flow generators 5. For example, the so-called feedback-free fluidic components can be used or components which generate an oscillating flow by means of colliding jets or by interacting vortices or recirculation areas inside the component.

The oscillation plane of the main flow generator 4 and the oscillation plane of the secondary flow generator 5 together enclose an angle of substantially 90°. However, embodiments in which the angle deviates from 90° are also conceivable. The main flow channel 403 of the main flow generator 4 and the main flow channel 503 of the secondary flow generator 5 comprise slightly different forms in the embodiment from FIG. 3. As an alternative to this, they can also be formed identically. In principle, therefore, it is possible to use structurally identical or different fluidic components as main flow generator 4 and as secondary flow generator 5.

In the embodiment shown in FIG. 3, the secondary flow generator 5 and the main flow generator 4 are arranged coaxially to one another. This means that the axis X₄ and the axis X₅ are aligned coaxially. Along with the embodiment shown here, the axis X₄ and the axis X₅ can also be aligned co-linearly (parallel) or approximately parallel to one another. Other relative arrangements of the axes X₄ and X₅ are also possible. The axes X₄ and X₅ in the embodiment from FIG. 9 thus enclose, for example, an angle of 90°.

The separator 6 (FIGS. 3 and 6) is arranged downstream of the second fluidic component (of the secondary flow generator) 5 and is traversable by the fluid flow which emerges from the secondary flow generator 5. The separator 6 comprises an inlet opening 601 and two outlet openings 602, the inlet opening 601 of the separator 6 corresponding to the outlet opening 502 of the secondary flow generator 5. The outlet openings 602 of the separator 6 are arranged, in this case, in a plane which corresponds to the oscillation plane of the secondary flow generator 5. The fluid flow emerging from the secondary flow generator 5 oscillates at the oscillation angle β between two maximum deflections. As a result of the oscillation of the fluid flow emerging from the secondary flow generator 5, said fluid flow is steered alternately to the one and to the other outlet opening 602 of the separator 6 so that two pulsing fluid jets are generated by the separator 6. The supply lines 7 are traversable by the pulsing fluid jets. The supply lines 7 each comprise an inlet opening 701 and an outlet opening 702. In this case, the inlet opening 701 of each supply line 7 corresponds to an outlet opening 602 of the separator 6. The fluid jets then flow in a pulse-like manner through the outlet openings 702 of the supply lines 7 out of the second fluidic part geometry II in order to interact with the fluid jet which emerges from the outlet opening 402 of the main flow generator 4.

FIG. 4 shows an enlarged representation of the detail A from FIG. 3. FIG. 4 shows the main flow generator 4 and the supply lines 7. The outlet openings 702 of the supply lines 7 and the outlet opening 402 of the main flow generator 4 each have a rectangular cross section. As an alternative to this, the cross section can comprise the form of an oval, trapezium, triangle, a diamond, a polygon or a mixed form. The rectangular cross sectional area of the outlet opening 402 of the main flow generator 4 is determined by the width b_{EX} and the depth t_{EX} of the outlet opening 402 (see FIGS. 7 and 9). The width b_{EX} extends, in this case, parallel to the oscillation plane of the main flow generator 4 and perpendicularly to the axis X₄ of the main flow generator 4, whilst the depth t_{EX} extends perpendicularly to the oscillation plane of the main flow generator 4 and perpendicularly to the axis X₄.

The outlet opening 3 of the fluidic assembly 1 also comprises a rectangular cross sectional area. The rectangular cross sectional area of the outlet opening 3 of the fluidic assembly 1 is determined in said embodiment by the width b_{EX} of the outlet opening 402 of the main flow generator 4 and by the distance between the two outlet openings 702. Said distance corresponds to the depth t_{EX} of the outlet opening 402 of the main flow generator 4 (see FIG. 7). Consequently, the outlet opening 3 of the fluidic assembly 1 and the outlet opening 402 of the main flow generator 4 are the same size. (In an alternative embodiment, the outlet opening 3 of the fluidic assembly 1 can be greater or smaller than the outlet opening 402 of the main flow generator 4.) The outlet width b_{EX} of the fluidic assembly 1 can be between 0.005 mm and 80 mm. A width b_{EX} of between 0.05 mm and 45 mm is preferred. A width b_{EX} of between 0.1 mm and 25 mm is particularly preferred. The outlet depth t_{EX} of the fluidic assembly 1 lies within the same value ranges as the outlet width b_{EX}, the outlet depth t_{EX} and the outlet width b_{EX} being able to be different sizes within the named value ranges.

The oscillation angle α of the main flow generator 4 and the oscillation angle β of the secondary flow generator 5 are determined by the outlet opening 3 of the fluidic assembly 1. If the cross sectional area of the outlet opening 3 of the fluidic assembly 1 is reduced whilst all other parameters remain unchanged, the oscillation angle α and/or the oscillation angle β is/are decreased as the fluid velocity in said cross sectional area increases. Consequently, the oscillation angle α and/or β can be adjusted by means of the size of the cross sectional area of the outlet opening 3 of the fluidic assembly 1.

The outlet openings 702 of the supply lines 7 also comprise in each case a rectangular cross sectional area. The rectangular cross sectional areas of the outlet openings 702 are formed with the same size and the same shape in said embodiment. The size of each cross sectional area is determined by the height h₇₀₂ of the outlet opening 702 and by the outlet width b_{EX} of the outlet opening 702 (FIGS. 7 and 9). In this case, the outlet width b_{EX} of the outlet openings 702 of the supply lines 7 corresponds to the outlet width b_{EX} of the outlet opening 402 of the main flow generator 4. The outlet width b_{EX} of the outlet openings 702 of the supply lines 7 extends parallel to the oscillation plane of the main flow generator 4 and perpendicularly to the axis X₄. The height h₇₀₂ of the outlet openings 702 of the supply lines 7 extends parallel to the oscillation plane of the main flow generator 4 and parallel to the axis X₄. The fluid of the secondary flow generator 5 (FIG. 5) flows in a pulse-like manner through the outlet openings 702 and is, in this case, directed to the fluid flow of the main flow generator 4 on this side and on the other side of the oscillation plane of the main flow generator 4. The velocity of the fluid at the outlet openings 702 preferably oscillates between a maximum velocity and 0, or, particularly preferred, between two maximum velocities with different signs. In the latter case, the fluid flows alternately out of the outlet openings 702 of the supply lines 7 and back into the supply lines 7 by realizing a transient, alternately unsteady flow.

FIG. 5 shows, in five snapshots I to V, a simulation of five flow situations offset in time for a fluid flow which traverses the fluidic assembly 1 from FIG. 3 and emerges from the same. The fluidic part geometries I and II are filled with water at a temperature of 25° in the simulation. The velocity of the fluid flow inside the fluidic assembly 1 and on the projection surface 8 is standardized to the value 1. In this case, the fluid flow in FIG. 5 is colored all the darker, the higher its velocity.

The velocity and the pressure of the fluid flow hardly influence the operability of the fluidic assembly in the embodiment shown. The fluidic assembly 1 thus operates for very small inlet pressures of a few mbar up to several hundred bar, such as, for example, for the range between 0.002 bar and 2500 bar. A pressure range of between 0.005 bar and 1800 bar is preferred and the pressure range of between 0.05 bar and 1100 bar is particularly preferred. The pressure specifications are relative to the ambient pressure. The velocity of the fluid flow 24, 25 in the main flow channels 403, 503 of the main flow generator 4 and of the secondary flow generator 5, however, influences the oscillation frequency of the fluid flows 24, 25 in the oscillation planes of the main flow generator 4 and of the secondary flow generator 5.

It can be seen by the change in the velocity field on the projection surfaces 8 of the individual part pictures I to V that the emerging fluid flow 20 is deflected in different directions in space and consequently wanders three-dimensionally in space. The movement path of the emerging fluid flow 20 can comprise very different forms on the projection surface 8. The fluid flow 20 can thus trace a rectangle or an oval, for example line by line or quasi chaotically or the path of a vertical and/or rotating figure of eight.

The kinematics of the emerging fluid flow 20 is influenced by the oscillation frequency and the oscillation angle α of the fluid flow of the main flow generator 4 and by the pulsation frequency of the fluid flow of the secondary flow generator 5 in combination with the separator 6. The homogeneity and/or the form (round, oval, almost triangular, polygonal or rectangular projection surfaces and mixed forms thereof) of the emerging fluid flow 20 can be influenced by modulating the characteristics of the fluid flows of the main flow generator 4 and of the secondary flow generator 5. Different movement paths of the fluid flow can be generated, in particular, by combining the dynamically changing oscillation angles α and β.

The angle at which the fluid flow 20 emerges from the fluidic assembly 1 can be determined by addition of the pulse of the fluid flow 24 of the main flow generator 4 and of the fluid flows 27 in the supply lines 7. On this basis, the main flow generator 4 and the supply lines 7 (here, in particular, the outlet openings 702 and the angle η (FIG. 7)) are able to be adapted for different technical applications.

FIG. 7 shows a detail of the main flow generator 4 and of the supply lines 7 from FIG. 6 in an enlarged manner. The component depth of the main flow generator 4 upstream of the outlet opening 402 is designated by way of t₄. The component depth t₄ is defined perpendicularly to the oscillation plane of the main flow generator 4. The component depth t₄ of the main flow generator 4 can be constant (as in the embodiment in FIGS. 6 and 7) or can taper or increase in size downstream in the region of the outlet opening 402 (t_{EX}). By tapering (t₄>t_{EX}) or enlarging (t₄<t_{EX}) the component depth of the main flow generator 4 in the region of the outlet opening 402, the velocity of the fluid flow can be increased or reduced with constant mass flow, as a result of which the oscillation angle β of the secondary flow generator 5 is able to be influenced. By varying the component depth of the main flow generator 4, the influence of the pulse transmission of the fluid flows in the supply lines 7 on the fluid flow of the main flow generator 4 can change. Consequently, with the geometry of the supply lines 7 unchanged, the oscillation angle β can be adjusted by varying the component depth of the main flow generator 4. In the embodiment in FIGS. 6 and 7, the depth t_{EX} of the outlet opening 402 and the depth t₄ of the main flow generator 4 are the same. The depth t₄ of the main flow generator 4 can lie within the range of between 0.005 mm and 90 mm. A preferred depth t₄ is between 0.04 mm and 50 mm. A particularly preferred depth t₄ lies within the range of between 0.1 mm and 30 mm.

The height h₇₀₂ of the outlet openings 702 determines the length of the portion of the fluid flow of the main flow generator 4 along the axis X₄ which interacts with the fluid flow of the secondary flow generator 5 emerging from the supply lines 7. The height h₇₀₂ is adjustable in dependence on the oscillation angle β of the secondary flow generator 5 and on the desired pulse transmission of the fluid flow of the secondary flow generator 5 to the fluid flow of the main flow generator 4. The height h₇₀₂ can be between 0.01 mm and 35 mm. A height h₇₀₂ of between 0.02 mm and 24 mm is preferred, and a height h₇₀₂ of between 0.05 mm and 18 mm is in particular advantageous. The height h₇₀₂ is smaller than or equal to a quarter of the component length l₄ of the main flow generator 4.

In this case, the length l₄ of the main flow generator 4 is the distance between the inlet opening 401 and the outlet opening 402 of the main flow generator 4 along the axis X₄ (FIG. 8). The inlet opening 401 and the outlet opening 402 are defined at the point where the cross sectional area of the fluidic component, which the fluid flow passes when it enters into the flow chamber 400 or emerges from the flow chamber again, is in each case smallest (locally). (Said definition of the inlet and outlet openings applies correspondingly to the secondary flow generator 5 and to the separator 6.) The length l₄ of the main flow generator 4 can be between 0.01 mm and 500 mm. A component length l₄ of the main flow generator 4 of between 0.02 mm and 350 mm is preferred. A component length l₄ of between 0.05 mm and 220 mm is particularly preferred.

In the embodiment in FIGS. 6 and 7, the supply lines 7 initially have a constant height h₇ downstream of their inlet openings 701. Further downstream (for example halfway along the supply lines 7) the height h₇ constantly reduces downstream until it reaches the height h₇₀₂ at the outlet openings 702. The height h₇ is defined, in this case, as the diameter of the supply lines 7 in the oscillation plane of the secondary flow generator 5 and perpendicularly to the flow direction of the fluid flow of the secondary flow generator 5 in the supply lines 7.

The supply lines 7 are directed onto the fluid flow of the main flow generator 4 on this side and on the other side of the oscillation plane of the main flow generator 4. In this case, the fluid flow of the secondary flow generator 5 from the supply lines 7 impinges on the oscillation plane of the fluid flow of the main flow generator 4 at an angle η. The angle η is defined as the angle which is spanned by the oscillation plane of the main flow generator 4 (or by the boundary walls of the main flow generator 4 parallel to the oscillation plane thereof) and a tangent on a central line of curvature 70 of the supply lines 7. The central line of curvature 70 extends, in this case, centrally through the supply lines 7. The tangent is shown in FIG. 7 by a dotted line as an example of a point on the central line of curvature 70 at the outlet opening 702. The angle η is different depending on the distance between the point on the central line of curvature 70 and the outlet opening 702, the angle η approaching 90° as the distance is reduced. In the embodiment in FIG. 7, the angle η for the point on the central line of curvature 70 at the outlet opening 702 is 92°. The angle η (for the point on the central line of curvature 70 at the outlet opening 702) can be between 30° and 150°. An angle η of between 60° and 120° is preferred (for the point on the central line of curvature 70 at the outlet opening 702). An angle η of between 75° and 110° is particularly preferred (for the point on the central line of curvature 70 at the outlet opening 702). The angle η determines the direction of the pulse of the fluid flow of the secondary flow generator 5. As a result, the oscillation angle β of the fluid flow of the secondary flow generator 5 can also be influenced.

The supply lines 7 can be designed in the region of their outlet openings 702 with regard to the angle η and to the central line of curvature 70 such that as uniform or constant a velocity profile of the fluid flow of the secondary flow generator 5 is realized at the outlet openings 702. It is advantageous when the velocity profile is slightly asymmetrical over the height h₇₀₂. The velocity profile is preferably as constant as possible along the width b₇ of the supply lines 7 or the width b_{EX} of the outlet openings 702 of the supply lines 7 (FIG. 9). The width b₇ is the extent of the supply lines 7 transversely to the flow direction of the fluid flow in the supply lines 7 and substantially parallel to the oscillation plane of the fluid flow of the main flow generator 4. In the embodiment from FIGS. 8 and 9, the width b₇ is initially constant and then increases constantly downstream until it reaches the width b_{EX} at the outlet opening 702.

In order to generate a velocity profile as homogenous as possible at the outlet openings 702 of the supply lines 7, the supply lines 7 can comprise at least one portion in which the size of the cross sectional area of the supply lines 7 decreases downstream. The cross sectional area is the area which is traversable by the fluid flow. As a result of such a convergent portion, the fluid flow can be accelerated within the supply lines 7. In order to obtain a desired profile of the fluid flow at the outlet opening 702, a (divergent) portion, in which the size of the cross sectional area of the supply lines 7 increases downstream, can be provided downstream of the convergent portion. The cross sectional areas do not have to change transversely to the flow direction in all directions inside the plane in a uniform manner in the convergent and divergent portions. As an alternative to this, additional elements can be arranged in or on the supply lines 7 for homogenizing the fluid flow, as, for example, guide vanes or (honeycombed/hexagonal) grid structures.

The pulse of the fluid flow, which emerges from the supply lines 7, is additionally determined by the cross sectional areas of the outlet openings 702. The diverting additions 7 are preferably formed such that the cross sectional area of the supply lines 7 upstream of the outlet opening 702 and in particular at the inlet opening 701 of the supply line 7 is greater than at the outlet opening 702. The cross sectional area of the outlet opening 702 is, in particular, between 70% and 100% of the cross sectional area of the supply lines 7 upstream of the outlet opening 702 and between 70% and 100% of the cross sectional area of the inlet opening 701 of the supply lines 7. In the case of incompressible fluids, the cross sectional area of the outlet opening 702 should be between 80% and 100% of the cross sectional area of the supply lines 7 upstream of the outlet opening 702 and between 80% and 100% of the cross sectional area of the inlet opening 701 of the supply lines 7. The cross sectional areas of the supply lines 7 are rectangular in said embodiment. In principle, other forms of cross sectional area are also conceivable.

FIG. 9 shows a sectional representation of the outlet opening 402 of the main flow generator 4 along the oscillation plane of the fluid flow of the main flow generator 4, a top view of an outlet opening 702 of one of the two supply lines 7 and of an outlet portion 33, which connects to the outlet opening 402 of the main flow generator 4. The outlet portion 33 is delimited at two oppositely situated sides (parallel to the oscillation plane of the main flow generator 4) each by one of the outlet openings 702 of the two supply lines 7 and at two oppositely situated sides (perpendicularly to the oscillation plane of the main flow generator 4) each by a boundary wall 34. The boundary walls 34 are slightly rounded at their end directed in opposition to the main flow direction of the fluid flow. The rounded form includes a circle segment with the radius r which is defined in the oscillation plane of the fluid flow of the main flow generator 4. The radius r can assume the value of zero in the extreme case, that is to say that the end of the boundary wall 34 directed in opposition to the main flow direction is realized as an edge. The radius r can consequently be, for example, between 0 mm and 15 mm. However, the end of the boundary wall 34 directed in opposition to the main flow direction is preferably rounded so that the radius r is preferably greater than 0 mm. The radius is preferably between r>0 mm and 12 mm and particularly preferred between >0 mm and 7 mm. The end of the boundary wall 34 directed in the main flow direction of the fluid flow is preferably realized as an edge, that is to say the radius here corresponds to 0.

The boundary walls 34 enclose an angle γ (in the oscillation plane of the main flow generator 4). Said angle γ can influence the oscillation angle α of the main flow generator 4. In the case where the angle γ is smaller than the oscillation angle α of the fluid flow emerging from the main flow generator 4, the oscillation angle α is delimited by the angle γ. The angle γ is preferably identical to the oscillation angle α or greater than the oscillation angle α. The angle γ can assume, for example, values of between 5° and 175°. Said angle is frequently determined by the installation space available. Insofar as the angle γ is greater than the oscillation angle α, the fluid flow is sucked onto the boundary walls 34 by means of the Coanda effect, as a result of which the oscillation angle α is increased to the angle γ.

FIG. 10 shows, in part images I and II, two different examples of fluidic components which can be used as main flow generators 4 of the fluidic assembly 1. In this case, the fluidic component from part image I corresponds to the main flow generator 4 of the fluidic assembly 1 from FIGS. 1 to 9.

With regard to the operating principle of the realization of an oscillating flow, the fluid component from part image II corresponds to the fluid component from part image I. Thus, in both fluidic components secondary flow channels 404 are used for realizing an oscillating fluid flow. In addition, separators 405 in the form of bulges (the boundary wall of the flow chamber 400) are provided at the inlet of the secondary flow channels 404 in the case of the fluidic component from part image II. In this case, at the inlet of each secondary flow channel 404, a bulge 405 projects in each case above a portion of the circumferential edge of the secondary flow channel 404 into the respective secondary flow channel 404 and changes the cross sectional area thereof at this point by decreasing the cross sectional area. The separation of the secondary flows from the main flow is influenced and controlled by the separators 405.

An outlet portion 33, which widens constantly downstream of the outlet opening 402 in the oscillation plane of the fluid flow of the main flow generator 4, connects directly downstream of the outlet opening 402. The outlet portion 33 has a trapezoidal cross section when viewed in the oscillation plane of the fluid flow of the main flow generator 4. The outlet portion 33 is delimited at two oppositely situated sides (parallel to the oscillation plane of the main flow generator 4) each by one of the outlet openings 702 of the two supply lines 7 and at two oppositely situated sides (perpendicular to the oscillation plane of the main flow generator 4) each by a boundary wall 34. The outlet portion 33 extends along the main flow direction (along the axis X₄ of the main flow generator 4, or along the height h₇₀₂ of the outlet openings 702 of the supply lines 7) over a length l₃₃. The length l₃₃ is the distance between the outlet opening 402 of the main flow generator 4 and the outlet opening 3 of the fluidic assembly 1 along the axis X₄ of the main flow generator 4. The height h₇₀₂ of the outlet openings 702 of the supply lines 7 can differ from the length l₃₃ of the outlet portion 33. In particular, the height h₇₀₂ of the outlet openings 702 can be shorter than the length l₃₃, the outlet openings 702 extending from the outlet opening 402 of the main flow generator 4 toward the outlet opening 3 but not reaching the outlet opening 3. For this purpose, for example, the material thickness h_{w} of the boundary wall of the supply lines 7 arranged downstream can be chosen to be correspondingly large. As a result of said design, on the one hand the pulse of the fluid jet from the supply lines 7 can be focused on the fluid jet of the main flow generator 4 and, on the other hand, greater mechanical stability can be achieved for the boundary wall of the supply lines 7 arranged downstream. As an alternative to this, the outlet openings 702 of the supply lines 7 can also reach from the outlet opening 402 of the main flow generator 4 to the outlet opening 3. In said case, the height h₇₀₂ of the outlet openings 702 and the length l₃₃ of the outlet portion 33 are the same size.

The cross sectional form of the outlet portion 33 (when seen in the oscillation plane of the main flow generator 4), as shown in the part image II in FIG. 10, can be trapezoidal or can be in other forms (rectangular, polygonal, triangular, oval, mixed form thereof). Corresponding to the form, the width b₃₃ of the outlet portion 33 can consequently be constant or also not constant. The width b₃₃ is preferably at least 65% of the width b_{EX} of the outlet opening 402 of the main flow generator 4. In a particularly preferred manner, the width b₃₃ is at least 80% of the width b_{EX} of the outlet opening 402 of the main flow generator 4. For example, the width b₃₃ of the outlet portion 33 can alter (enlarge) downstream in such a manner that the boundary walls 34 substantially enclose the angle γ. Corresponding to the form of the outlet portion 33 in the oscillation plane of the main flow generator 4, the outlet openings 702 of the supply lines 7 can be formed in an identical manner.

FIG. 11 shows, in the part images I and II, two different embodiments of the separator 6. The two separators 6 shown differ in the form of the flow distributer 603. The flow distributer 603 divides the oscillating fluid flow, which flows from the inlet opening 601 into the separator 6 in such a manner that the oscillating fluid flow flows alternately through one of the two outlet openings 602. In the two embodiments shown, two outlet openings 602 are shown. In principle, the separator 6 can also comprise more than two outlet openings. A pulsing flow, which flows into the supply lines 7, is generated by means of the separator 6 in combination with the fluidic component 5. The velocity of the fluid flow inside the supply lines 7 or at the outlet openings 602 of the separator 6 is preferably briefly periodically approximately 0 or the velocity is reduced (to, for example, 75% of the maximum velocity). It is particularly advantageous when the flow direction of the fluid changes briefly periodically, that is to say the sign of the velocity field changes briefly periodically in the outflow direction.

Two different embodiments of the separator 6 are suitable for these purposes (in combination with the secondary flow generator 5). In this case, the secondary flow generator 5 and the separator 6 can be realized in one piece or as individual elements. The first embodiment (part image I) generates a substantially binary or digital flow pattern. Said embodiment can be used in the case of higher oscillation frequencies (from around 100 Hz). A flow signal, which almost corresponds to a rectangular function, can be generated with said embodiment at each outlet opening 702 of the supply lines 7, the rectangular functions for the two outlet openings 702 being displaced by half a phase toward one another. In the embodiment from part image I, the fluid flow is not divided by a sharp edge but is steered into the outlet opening 602 reciprocally by an inner curved wall 603 as flow distributor. The curved wall 603 is arranged, in this case, between the two outlet openings 602 and is arched outward (when viewed along the axis X₅ in the fluid flow direction). As a result of the curvature of the inner wall 603, an indentation (recess) is generated. The cross sectional area of the outlet openings 602 is in each case greater than or equal to the cross sectional area of the inlet opening 601. As a result, the effect of the binary flow pattern can be supported. In particular in the case of fluids with a high density and incompressible media, cross sectional areas of the outlet openings 602, which are greater than the cross sectional area of the inlet opening 601, are advantageous. In addition, the space between the inner curved wall 603 and the inlet opening 601 can be realized with regard to form and size in such a manner that a vortex is generated there. Said vortex supports the previously mentioned velocity reduction or velocity reversal at the outlet openings 702 of the supply lines 7. The effect of the binary flow pattern can also be supported as a result.

The second embodiment (part image II) generates a substantially analogue flow pattern. The second embodiment is advantageous, in particular, for compressible fluids and in the case of applications with a low oscillation frequency (as a rule below 200 Hz). In the case of said embodiment, the inner wall 603 is realized as a wedge which projects into the separator 6 in opposition to the fluid flow direction substantially along the axis X₅. Here too, the cross sectional area of the outlet openings 602 is in each case greater than or equal to the cross sectional area of the inlet opening 601.

FIGS. 13 and 14 show a further embodiment of the invention. Said embodiment differs from the embodiment from FIGS. 1 to 9 in particular by the relative arrangement of the first fluidic part geometry I and of the second fluidic part geometry II. In addition, the size ratios of the first fluidic part geometry I and of the second fluidic part geometry II are different compared to the embodiment from FIGS. 1 to 9. In the case of the embodiment from FIGS. 13 and 14, the axis X₄ of the main flow generator 4 and the axis X₅ of the secondary flow generator 5 are not arranged coaxially (one after the other) but the axes X₄ and X₅ enclose an angle with one another of substantially 90°. The oscillation planes of the main flow generator 4 and of the secondary flow generator 5 enclose an angle with one another of substantially 90°.

When maintaining a fixed angle between the oscillation planes of the main flow generator 4 and of the secondary flow generator 5, a change in the angle between the axis X₄ of the main flow generator 4 and the axis X₅ of the secondary flow generator 5 has no significant effect on the operation of the fluidic assembly 1. The relative arrangement of the two fluidic part geometries I and II is frequently predefined by the available installation space.

As soon as the axis X₄ of the main flow generator 4 and the axis X₅ of the secondary flow generator 5 are no longer aligned substantially coaxially or parallel, the geometry of the supply lines is to be designed, where necessary, in a manner deviating from the embodiment from FIGS. 1 to 9.

Also in the embodiments in FIGS. 13 and 14 (analogous to the embodiment from FIGS. 1 to 9) the fluid flow, which emerges from the outlet openings 702 of the supply lines 7, preferably comprises as uniform a profile as possible along the width b_{EX} of the outlet opening 702. However, in the embodiment of FIGS. 13 and 14, the width b₇ (b_{EX}) of the supply lines 7 (of the outlet openings 702) is defined as the diameter of the supply lines 7 in the oscillation plane of the secondary flow generator 5 and perpendicularly to the flow direction of the fluid flow of the secondary flow generator 5 in the supply lines 7. Correspondingly, the height h₇ (h₇₀₂) of the supply lines 7 (of the outlet openings 702) is defined as the extent of the supply lines 7 transversely to the flow direction of the fluid flow in the supply lines 7 and substantially parallel to the oscillation plane of the fluid flow of the main flow generator 4. Accordingly, the definitions of the widths b₇ and b_{EX} and of the heights h₇ and h₇₀₂ in the two embodiments of FIGS. 1 to 9 or 13 and 14 are interchanged.

In the embodiment of FIGS. 13 and 14, the width b₇ of the supply lines is initially constant and then increases constantly downstream until it reaches the width b_{EX} at the outlet opening 702. The supply lines 7 have initially a constant height h₇ downstream of their inlet openings 701. Further downstream, (for example halfway along the supply lines 7) the height h₇ constantly reduces downstream until it reaches the height h₇₀₂ at the outlet openings 702.

The width of the outlet opening 702 of the supply lines 7 can be up to 30% greater or smaller than the width b_{EX} of the outlet opening of the main flow generator 4. As a result, the producibility can be simplified.

The size of the cross sectional area of the supply lines 7 is preferably as constant as possible along the extension direction of the supply lines 7, in spite of the height and width of the supply lines 7 changing along the extension direction of the supply lines 7. However, the size of the cross sectional areas can reduce by up to 30% downstream toward the outlet openings 702 of the supply lines 7. In a preferred manner, the cross sectional area of the supply lines 7 is a maximum of 30% smaller than the cross sectional area of the inlet opening 701 in an arbitrary portion of the supply lines between the inlet opening 701 and the outlet opening 702. The cross sectional area of the outlet opening 702 is preferably no more than 30% smaller than the cross sectional area of the supply line 7 upstream of the outlet opening 702. In the case of low-pressure applications of less than 250 bar inlet pressure, the deviation is preferably less than 20%.

FIG. 15 shows, in the part images in I and II, two snapshots of the fluid which emerges from the fluidic assembly according to FIGS. 1 to 9, the two snapshots showing the fluid flow at the same moment but from different directions. An angle of, for instance, 80° lies between the two directions in the part images I and II. It can be seen in both images that the fluidic assembly 1 generates a fluid jet which oscillates not only in a spatial plane but in two planes, and consequently the fluid jet carries out a three-dimensional vibration. Said fluid flow comprises an almost rectangular spray pattern. Such a spray pattern is suitable, for example, for cleaning and spray distribution applications.

The forms of the fluidic components which are shown in the fluid assembly according to the invention in FIGS. 1 to 15 are only as an example. As an alternative to this, it is also possible to use fluidic components which generate an oscillation by means of colliding fluid jets or by means of interacting vortices or recirculation areas or which have means for realizing an oscillation of the fluid flow other than secondary flow channels (feedback-free fluidic components).

FIGS. 16 to 21 show different views of a fluidic component, the so-called cup component, according to an embodiment. In this case, only the inner operating geometry of the cup component 10 is shown. The exterior form can be chosen as required. The cup component only includes one fluidic geometry (in contrast to the fluidic assembly 1 from FIGS. 1-15). Said fluidic geometry includes a flow chamber 100 which is traversable by a fluid flow which enters into the flow chamber 100 through an inlet opening 101 and emerges from the flow chamber 100 through an outlet opening 102. In said embodiment the inlet opening 101 and the outlet opening 102 each have a circular cross sectional area. In principle, other forms can also be used. The center points of the inlet opening 101 and of the outlet opening 102 lie on an axis X₁ which predefines the main flow direction inside the cup component 10. The flow chamber 100 includes a main flow channel 103 and five secondary flow channels (feedback channels) 104a-e.

The number of secondary flow channels 104a-e is only as an example. The cup component 10 can also comprise a different uneven number (at least three) of secondary flow channels. The secondary flow channels 104a-e are realized substantially identically. However, they can also be realized in a different manner. The secondary flow channels 104a-e are provided as a means for realizing an oscillation of the fluid flow. In this case, the secondary flow channels 104a-e are arranged evenly around the main flow channel 103 (when viewed along the axis X₁). Evenly means that the identical angle α always lies between two adjacent secondary flow channels, here namely 360°/5=72°. Said arrangement of the secondary flow channels avoids two secondary flow channels and the main flow channel being able to be arranged in one plane, wherein the main flow channel would be arranged between the two secondary flow channels. The angle σ between adjacent secondary flow channels 103 can also be different insofar as the angles σ are chosen in such a manner that no two secondary flow channels and the main flow channel are arranged in one plane. The oscillation angles of the fluid flow emerging from the cup component 10, the form and the size of the projection surface of the fluid jet can be influenced by the angle σ. The secondary flow channels 104a-e branch off from the main flow channel 103 (directly) downstream of the inlet opening 101 and combine with the same again (directly) upstream of the outlet opening 102. The secondary flow channels 104a-e, when viewed in the main flow direction, are initially directed from the inlet opening 101 to the outlet opening 102 and reverse their direction substantially just in front of the outlet opening 102. The cross sectional areas of the secondary flow channels 104a-e are round in this embodiment; however, they can be realized in an arbitrary manner.

The main flow channel 103 comprises chambers 110a-e, the number of which corresponds to the number of secondary flow channels 104a-e. In this case, each chamber 110a-e is connected fluidically to a secondary flow channel 104a-e. The chambers 110a-e are formed by the outside wall of the main flow channel 103 and are open in the direction of the axis X₁. In the embodiment shown, the chambers 110a-e comprise a substantially semi-circular outside wall (FIG. 21) in the cutting plane transversely to the axis X₁. Other forms, in particular asymmetrical forms, are also possible insofar as the chambers 110a-e are open to the axis X₁. The forms are preferably constant and comprise a curvature. In this case, the outside wall of the individual chambers 110a-e can project into the flow chamber 100 to different degrees. The outside wall of a chamber can also be realized asymmetrically. This means that the boundary wall can project into the flow chamber more on one side of the chamber than on the other side of the chamber and/or that the wall can be aligned asymmetrically on both sides of the chamber. In addition, the dimension by which the outside wall projects into the flow chamber on the individual sides of the chambers can be constant or vary over the length l of the cup component.

In particular, the chambers 110a-e can be twisted about the axis X₁. The twisting can be pronounced to varying degrees and reach from a few seconds to multiple degrees (even more than 360°). The achievement of the twisting is that the fluid is conducted into the adjacent chambers 110a-e.

The main flow channel 103 with the individual chambers 110a-e is formed such that the cross sectional area of the main flow channel 103, transversely to the axis X₁ proceeding from the inlet opening 101, initially becomes larger downstream and then tapers again. The outside wall of the tapering portion encloses an angle ε with the axis X₁. The tapering portion (when viewed along the axis X₁) is shorter than the enlarging portion. For example, the enlarging portion can be twice as long as the tapering portion. The form of the outside wall of the main flow channel 103 changes non-constantly at the transition between the enlarging portion and the tapering portion.

The fluid flows through the inlet opening 101 into the main flow channel 103 where it contacts predominantly the wall of one of the five chambers 110a-e as a result of the Coanda effect and flows in the direction of the outlet opening 102. The largest part of the fluid leaves the cup component 10 through the outlet opening 102. A small part of the fluid does not leave the component 10 but passes directly upstream of the outlet opening 102 into the secondary flow channels 104a-e. At the same time, a varying amount of fluid passes into the individual secondary flow channels 104a-e, the predominant part flowing into the secondary flow channel 104a-e which is connected to the chamber 110a-e, the wall of which the inflowing fluid has contacted. In the secondary flow channels 104a-e the fluid flows in the direction of the inlet opening 101. The returning fluid portion emerges from the secondary flow channels 104a-e directly downstream of the inlet opening 101 and urges the fluid entering through the inlet opening 101 into a chamber other than the chamber that was filled predominantly in the preceding cycle. As no two chambers 110a-e and no two secondary flow channels 104a-e lie diametrically opposite one another, no oscillation is able to be realized in a plane in which the two chambers 110a-e and two secondary flow channels 104a-e are arranged. The achievement is rather that the fluid flow is steered alternately into the different chambers 110a-e and an emerging fluid jet, which is moved three-dimensionally in space and, in this case, oscillates between multiple points (five here), is consequently generated. In order to generate the dynamically moving fluid jet, a transient flow is generated inside the cup component 10. The movement of the emerging fluid flow can be influenced by the fluid velocity and the angle ε.

The secondary flow channels 104a-e can each be aligned to a preferred chamber 110a-e so that the fluid jet emerging from the secondary flow channels 104a-e steers the fluid flow entering at the inlet opening 101 into the corresponding preferred chambers 110a-e.

The length l of the cup component 10 can assume values of between 0.1 mm and 1000 mm. Preferred lengths l are within the range of between 0.15 mm and 500 mm. The length is defined as the distance between the inlet opening 101 and the outlet opening 102 along the axis X₁, the inlet opening 101 and the outlet opening 102 each being defined at the point where the cross sectional area of the fluidic component, which the fluid flow passes when it enters into the flow chamber 100 or emerges again from the flow chamber, is in each case smallest (locally).

The cup component comprises a divergent part 112 having the length lₒᵤₜ (FIG. 18) downstream of the outlet opening 102. The divergent part is, however, optional. Said divergent part 112 can take over various tasks. One task is the concentrating of the jet emerging from the outlet opening 102. The divergent part can also be utilized for the purpose of reducing or increasing the size of the oscillation angle of the emerging jet.

FIG. 22 shows a cup component 10 according to a further embodiment. Said embodiment differs from that from FIGS. 16 to 21 in that the secondary flow channels 104a-e are fluidically interrupted. Rather, just one approach each is provided for the inlet openings and outlet openings. The approaches for the inlet openings and outlet openings are connectable, for example, to a tube or hose. For one thing, the inlet opening of a secondary flow channel can thus be connected to the associated outlet opening. However, the inlet opening of a secondary flow channel can also be connected to the outlet opening of another secondary flow channel. As a result, the alignment of the secondary flow channels can be individually adapted and the movement progression of the fluid jet emerging from the cup component can be influenced.

The cup component 10 from FIG. 22 is realized externally substantially in the form of a cylinder, the rotational axis of the cylinder extending along the main flow direction of the cup component. The external design is only as an example and can deviate from the form of a cylinder.

1. A fluidic assembly having a fluidic component, wherein the fluidic component comprises a flow chamber which is traversable by a fluid flow which enters into the flow chamber through an inlet opening of the flow chamber and emerges from the flow chamber through an outlet opening of the flow chamber, wherein the fluidic component comprises at least one means for realizing an oscillation of the fluid flow at the outlet opening, and wherein the oscillation is effected in an oscillation plane,
and further comprising a device for diverting the oscillating fluid flow which emerges from the outlet opening of the fluidic component, wherein the diverting is variable over time.

2. The fluidic assembly as claimed in claim 1, wherein the device for diverting the fluid flow provides a means for diverting the fluid flow in a manner that is variable over time, and wherein the means for diverting the fluid flow includes, in particular, a fluid.

3. The fluidic assembly as claimed in claim 2, wherein the device for diverting the fluid flow is arranged in such a manner that the means for diverting the fluid flow acts in such a manner on the oscillating fluid flow that the fluid flow is steered out of the oscillation plane.

4. The fluidic assembly as claimed in claim 2, wherein the device for diverting the fluid flow is arranged in such a manner that the means for diverting the fluid flow acts on the fluid flow substantially along an axis which encloses an angle which is greater than 0° with the oscillation plane of the oscillating fluid.

5. The fluidic assembly as claimed in claim 4, wherein the means for diverting acts on the fluid flow along the axis from the one direction, from the opposite direction or from both directions.

6. The fluidic assembly as claimed in claim 4, wherein the means for diverting acts on the fluid flow along the axis in an alternating manner from the one direction and from the opposite direction.

7. The fluidic assembly as claimed in claim 2, wherein the device for diverting the fluid flow is arranged in such a manner that the means for diverting the fluid flow acts on the fluid flow directly at the outlet opening of the flow chamber.

8. The fluidic assembly as claimed in claim 2, wherein the device for diverting the fluid flow is traversable by the means for diverting the fluid flow.

9. The fluidic assembly as claimed in claim 2, wherein the device for diverting the fluid flow includes a fluidic component.

10. The fluidic assembly as claimed in claim 2, wherein the device for diverting includes a separator in order to divide the means for diverting into at least two branches.

11. The fluidic assembly as claimed in claim 10, wherein the separator comprises an inlet opening and at least two outlet openings, wherein the cross sectional area of the at least two outlet openings is greater in each case than the cross sectional area of the inlet opening.

12. The fluidic assembly as claimed in claim 10, wherein separator opens out into at least two supply lines.

13. The fluidic assembly as claimed in claim 12, wherein the at least two supply lines are directed onto the oscillating fluid flow which emerges from the outlet opening of the fluidic component, wherein the at least two supply lines are directed onto the oscillating fluid flow on this side and on the other side of the oscillation plane of the oscillating fluid flow.

14. The fluidic assembly as claimed in claim 12, wherein the dimensions of the at least two supply lines are chosen in such a manner that the at least two supply lines reach to the outlet opening of the fluidic component and extend at the outlet opening of the fluidic component in each case at least over the entire width of the outlet opening of the fluidic component.

15. A device for generating a fluid jet,
wherein the device includes a fluidic assembly as claimed in claim 1, and wherein she device is a part of at least one of
a cleaning apparatus, in particular, a dishwasher, an industrial cleaning plant, a washing machine, a hand spray or a high-pressure cleaner,
a mixing system, in particular an injection system for injecting fuel into an internal combustion engine,
a cooling system which provides a fluidic coolant, and
an extinguishing system for extinguishing a fire, wherein the extinguishing system provides the fire-extinguishing fluid.

16.-18. (canceled)

19. A fluidic component having a flow chamber which is traversable by a fluid flow which enters into the flow chamber through an inlet opening of the flow chamber and emerges from the flow chamber through an outlet opening of the flow chamber, wherein the fluidic component comprises at least one means for realizing an oscillation of the fluid flow at the outlet opening, and
wherein the at least one means for realizing an oscillation includes an uneven number of secondary flow channels which is greater than 1.

20. The fluidic component as claimed in claim 19, wherein the flow chamber comprises a main flow channel which includes multiple chambers, the number of which corresponds to the number of secondary flow channels and which are each connected fluidically to a secondary flow channel, and wherein the chambers are open toward an axis which extends centrally from the inlet opening to the outlet opening.

21. The fluidic component as claimed in claim 20, wherein the chambers are twisted about the axis.
